(19) United States
(12) Patent Application Publication
(10) Pub. No.: US 2023/0334850 A1
(43) Pub. Date: Oct. 19, 2023

(54) MAP DATA CO-REGISTRATION AND LOCALIZATION SYSTEM AND METHOD

(71) Applicant: Condor Acquisition Sub II, Inc., Wilmington, DE (US)

(72) Inventors: Scott Harvey, San Francisco, CA (US); Sravan Puttagunta, Berkeley, CA (US)

(21) Appl. No.: 17/909,711

(22) PCT Filed: Mar. 23, 2020
(86) PCT No.: PCT/US2020/024316

§ 371 Date: Sep. 6, 2022

Related U.S. Application Data
(60) Provisional application No. 62/822,682, filed on Mar. 22, 2019.

(51) Int. Cl. G06V 20/17; G06V 20/10

(52) U.S. Cl. CPC G06V 20/17; G06V 20/182

(57) ABSTRACT

Embodiments of architecture, systems, and methods used to provide map data, sensor data, and asset signature data including location data, depth data, and positional data for a terrestrially mobile entity, location and positional data for pseudo-fixed assets and dynamic assets relative to the terrestrially mobile entity via a combination of aerial sensor data and terrestrial data. Other embodiments may be described and claimed.

### TECHNICAL FIELD

Various embodiments described herein relate generally to architecture, systems, and methods used to provide location and positional data for a terrestrial mobile entity, location and positional data for pseudo-fixed assets and dynamic assets relative to the terrestrially mobile entity, and semantic maps.

### BACKGROUND INFORMATION

Terrestrial mobile systems (TMS) may be employed in occupied or unoccupied vehicles, buses, trains, robots, very low altitude airborne systems, and other terrestrial mobile entities. A TMS may include machine vision/signal sensor modules, location determination modules, and map information and formation modules to attempt to navigate about an environment that may include pseudo-fixed assets and dynamic assets. Such TMS may employ a simultaneous location and map formation approach (sometimes referred to as SLAM) to attempt to enable a mobile entity to determine its position and pose, and to reliably and safely navigate about a terrestrial or very low altitude environment. However, precise positioning and localization using only terrestrial SLAM techniques typically require TMS modules that are expensive in terms of cost, physical size, and/or bandwidth, limiting their deployment to certain more expansive and larger mobile entities. Formation of a base map using only terrestrial SLAM may also be expensive, in terms of, for example, time, hardware resources and collection effort. Even when large volumes of SLAM data may be available, fusing of map data from multiple trips (whether by the same terrestrial entity or a different terrestrial entity) may be difficult, inasmuch as each trip's observed data may be generated using its own coordinate system, which may differ from coordinate systems from which other terrestrial entities observe. A need exists for architecture, systems, and methods that enable a mobile entity to reliably and safely navigate and/or determine its location with a high level of precision, but using less expensive TMS modules, and embodiments of the present invention provide such architecture, systems, and methods.

### BRIEF DESCRIPTION OF THE DRAWINGS

FIG. 1A is a simplified diagram of a navigation and location architecture for terrestrial mobile entities according to various embodiments.

FIG. 1B is a simplified image of a large environmental region that may be generated in part by aerial systems employed in an aerial entity of a navigation and location architecture according to various embodiments.

FIG. 1C is a simplified image of a smaller environmental region that may be generated in part by aerial systems of a navigation and location architecture according to various embodiments.

FIG. 1D is a block diagram of a navigation and location architecture for terrestrial mobile entities according to various embodiments.

FIG. 2A is a block diagram of a terrestrial mobile system that may be employed in navigation and location architecture for terrestrial mobile entities according to various embodiments.

FIG. 2B is a block diagram of another terrestrial mobile system that may be employed in navigation and location architecture for terrestrial mobile entities according to various embodiments.

FIG. 2C is a block diagram of a further terrestrial mobile system that may be employed in navigation and location architecture for terrestrial mobile entities according to various embodiments.

FIG. 3A is a block diagram of a navigation and location architecture for terrestrial mobile entities according to various embodiments.

FIG. 3B is a block diagram of another navigation and location architecture for terrestrial mobile entities according to various embodiments.

FIG. 3C is a block diagram of an octree for map resolution gradients in a map co-registration system (McRS) that may be employed in navigation and location architecture for terrestrial mobile entities according to various embodiments.

FIG. 4 is a block diagram of communications between a global navigation system, aerial system, map co-registration system (McRS), and terrestrial mobile system in navigation and location architecture for terrestrial mobile entities according to various embodiments.

FIG. 5 is a block diagram of an article according to various embodiments.

FIG. 6 is a block diagram of an article according to various embodiments.

### DETAILED DESCRIPTION

Occupied or unoccupied vehicles, buses, trains, scooters, robots (such sidewalk robots and delivery robots or vehicles), very low altitude airborne systems, and other terrestrial mobile entities (TME) may desirably navigate about their environment without human guidance or intervention. A TME or User may also want to precisely determine their location in their environment.

In an embodiment, their environment may include a topology with fixed or pseudo-fixed navigation areas where they may navigate or are permitted to move. Their environment may also include pseudo-fixed assets such as buildings, corridors, streets, pathways, canals, navigational markings, plants (such as trees), and natural attributes such as rivers, bodies of water, changes in elevation (such as hills, valleys, mountains). These assets may be termed pseudo-fixed assets as building may be modified, trees planted, moved, or cut down, rivers dammed or bridged, and tunnels formed in mountains. Even the topology and fixed or pseudo-fixed navigation areas may change with the addition or removal of pathways (roads or bridges moved, changed, or removed).

In an embodiment, aerial entities 220 may map an environment from above including the topology with fixed or pseudo-fixed navigation areas and pseudo-fixed assets. The map may include precise reference points or point cloud datum cloud data that may indicate the precise location and height of various elements in the environment. A three-dimensional (3D) image of an environment 100 may also be formed from the map as the aerial entities 220 move over an environment and be fused with point cloud data to form a fused map that includes point and image data. In an embodiment, another system, a map co-registration system (McRS) 30A may process or receive data from the aerial entities 220 to form fused maps with reference points and 3D models or attributes. A TME 240, 250 via a terrestrial mobile system (TMS) 40A may also provide image (from monocular and stereo digital cameras), radar, depth detection systems including light detection, and ranging (LIDAR) unit, multiple radars creating inSAR, WiFi, Bluetooth, other wireless signal data, signatures, and other map data to a map co-registration system (McRS) 30A, which a McRS 30A may use to improve, enhance, or modify fused map data. Further, a McRS 30A may receive image, radar, depth detection systems including light detection, and ranging (LIDAR) unit, multiple radars creating inSAR, WiFi, Bluetooth, other wireless signal data, signatures, and other map data from other assets in the environment including pseudo fixed assets and dynamic assets.

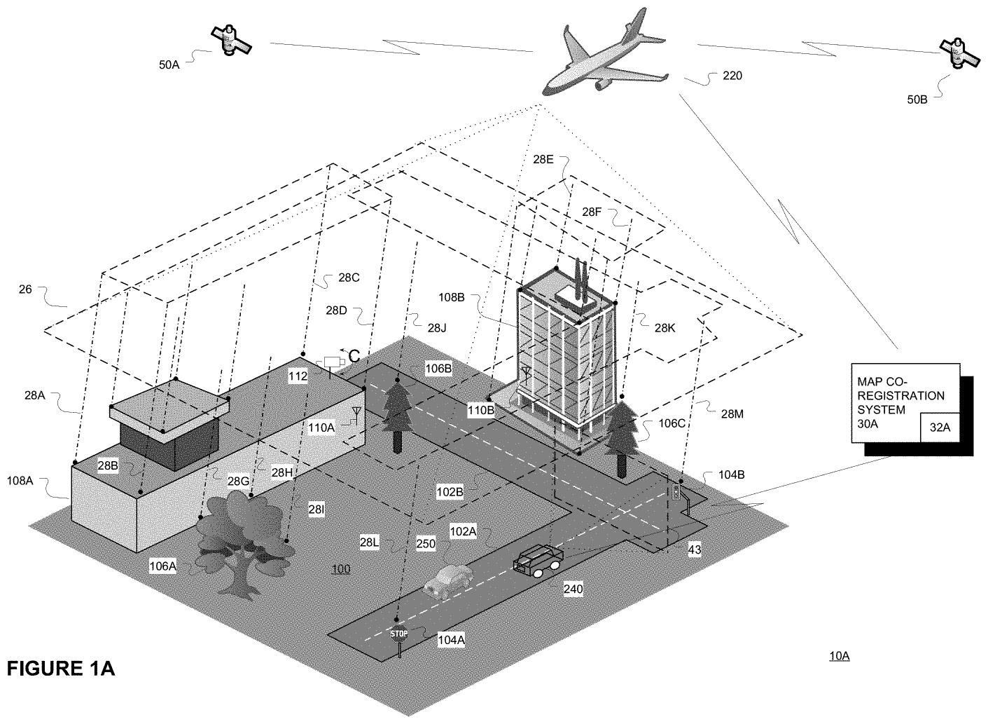

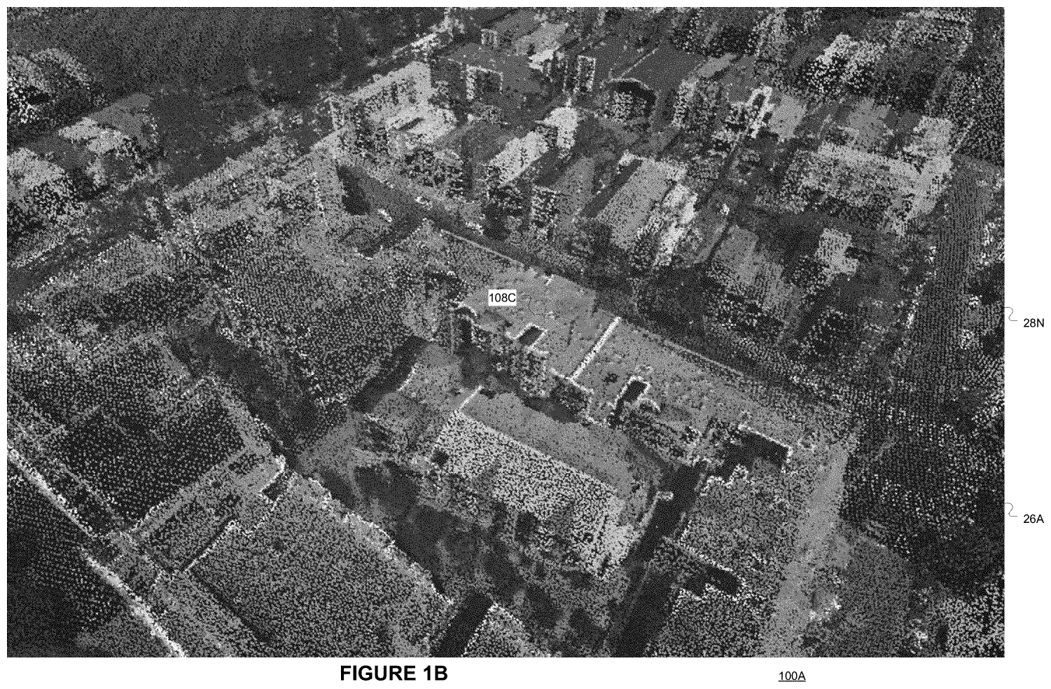

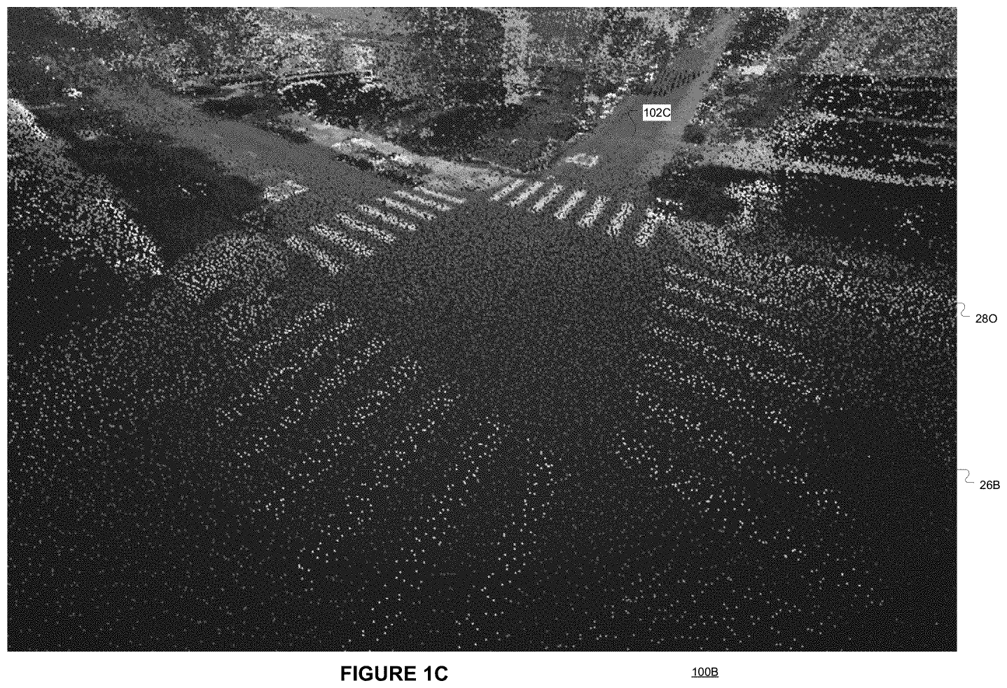

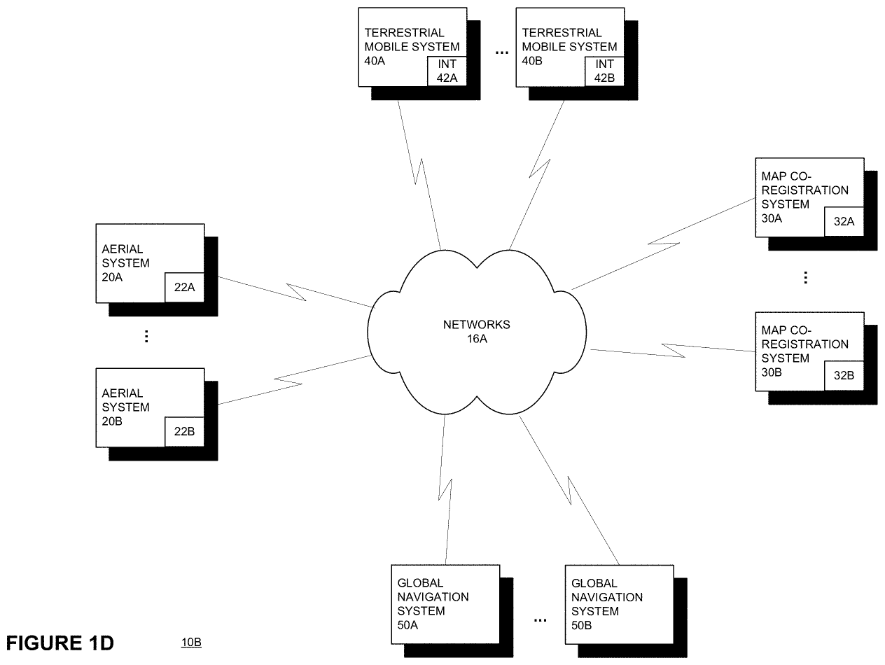

In an embodiment, a McRS 30A, aerial system 20, or TMS 40A, 40B alone or various forms of conjunction may form a fused map via a structure in motion process. An aerial system 20 may generate a map including image data, positional data, and point cloud data where segments of the image data are tied to the point cloud data and the point cloud data may be anchored to positional data (such as GPS data). In an embodiment, an aerial system 20 may also employ multiple radars to create digital elevation modules using various techniques including interferometric synthetic aperture radar (inSAR). Such evaluation data may be combined with digital image data and point cloud data to from complex fused maps. In addition, terrestrial data about an environment 10 may be provided to an aerial system 20 where the terrestrial data may provide additional data or modeling layers including vertical features that aerial data alone may not generate such as certain pseudo-fixed navigation areas and pseudo-fixed assets including signs, signals or poles (104A in FIG. 1A). The terrestrial data may include terrestrial image (monocular and stereo digital camera data), depth data such as LIDAR point cloud datums, inSAR data, and other depth data, and radar data that has been georeferenced. Via such data, aerial systems 20 data may form an initial semantic or 3D map.

An aerial system 20 and McRS 30A may form partial 3D or semantic maps via the initial aerial system 20 data and terrestrial data in an embodiment. An aerial system 20 and McRS 30A may also form signature data including voxel signature data for pseudo-fixed assets 104A-B, 106A-C, and 108A-B in an environment 100. As noted, a TMS 40A, 40B of a TME 240, 250 may provide an additional image data image, radar, depth detection systems including light detection, and ranging (LIDAR) unit, multiple radars creating inSAR, WiFi, Bluetooth, other wireless signal data, and other data forming a dataset to a McRS 30A and an aerial system 20 as the TME 240, 250 moves through an environment 100. In an environment 100, pseudo assets 108A may also provide data 112 including image, radar, depth detection systems including light detection, and ranging (LIDAR) unit, multiple radars creating inSAR, WiFi, Bluetooth, other wireless signal data via camera 112 and antenna 110A to a TMS 40A, 40B, McRS 30A, and aerial system 20 in an embodiment.

The TMS 40A, 40B may also include form signature data including voxel signature data for pseudo-fixed assets 104A-B, 106A-C, and 108A-B in an environment 100 and communicate such data to a McRS 30A and an aerial system 20 where the signature data may be formed based on image, radar, depth detection systems including light detection, and ranging (LIDAR) unit, multiple radars creating inSAR, WiFi, Bluetooth, other wireless signal data collected by a TMS 40A, 40B or provided by the environment 100 in architecture 10A.

A McRS 30A and an aerial system 20 via structure in motion or other techniques may improve or fuse their map data with the TMS 40A, 40B data and environment asset data to form more complete fused map data representing semantic and 3D maps of the environment. In an embodiment, a McRS 30A, an aerial system 20, and an TMS 40A, 40B may employ match or correlate data sets provided between systems 30A, 20, 40A, 40B using several methods. In an embodiment, a system 30A, 20, 40A, 40B may match datasets via common landmarks or pseudo-fixed assets located at various locations including at ground level. In an embodiment, a system 30A, 20, 40A, 40B may match datasets via depth measurements in the datasets, signature matching, and iterative Closet Point (ICP). A system 30A, 20, 40A, 40B may match depth data via a combination of structure in motion and photogrammetry. An embodiment of the invention may combine any these techniques to correlate datasets between systems 30A, 20, 40A, 40B.

A fused map may have depth data including point cloud data and inSAR data to provide unique anchors within the fused map enabling more precise fused map generation. In addition, an McRS 30A, an aerial system 20, and TMS 40A, 40B signature data including voxel signature data for pseudo-fixed assets 104A-B, 106A-C, and 108A-B in an environment 100 may also add to the precision and formation of fused semantic and 3D maps of the environment. In an embodiment, a TMS 40A, 40B may receive aerial system 20, environment 100 asset datasets 108A, 108B datasets, and McRS 30A map datasets and fuse such data with their data to form fused semantic and 3D maps of the environment 100 as described.

Similarly, an aerial system 20A may receive TMS 40A, 40B datasets, and McRS 30A map datasets and fuse such datasets with their datasets to form fused semantic and 3D maps of the environment 100 as described. Such a TMS 40A, 40B may upload their resultant maps to the aerial system 20 and McRS 30A. Aerial data georeferenced accuracy can be upgraded by the accuracy of terrestrial data. For example, less accurate ortho-images from aerial or satellite based aerial systems 20A may be matched against high accuracy depth data such as LIDAR point cloud datums, inSAR data, and other depth data to provide color information from TMS 40A, 40B data. The color information may be used to classify lane markings as white or yellow to better define an environment 100. In either case, data from an aerial system 20A or TMS 40A, 40B may be used to detect changes in the environment 100 including to various assets 104, 102, 108 in an environment 100. It is noted that data and datasets may be used interchangeably as nomenclature to represent data from multiple sensors and sources.

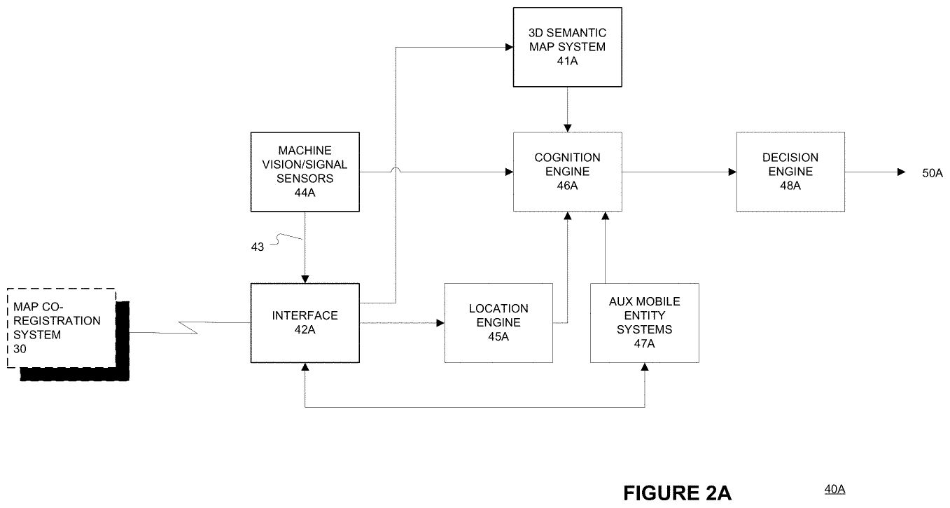

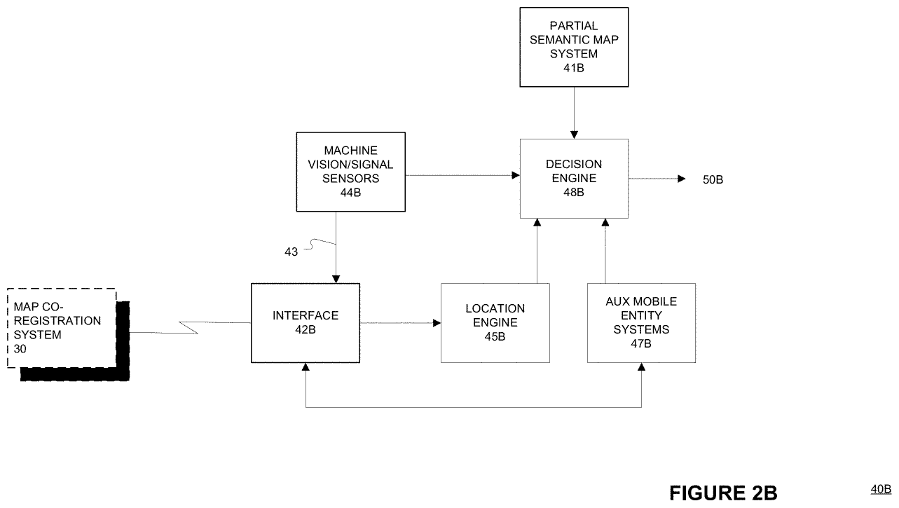

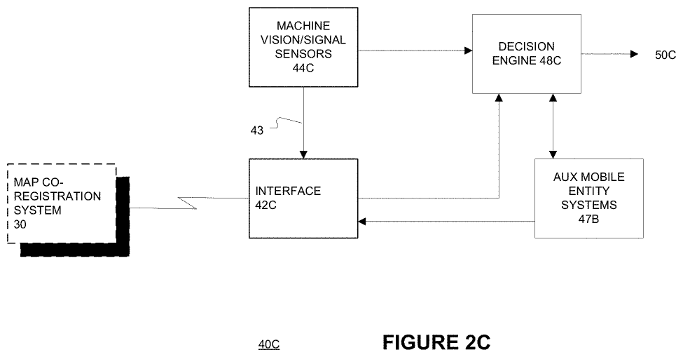

In an embodiment, a TME 240 via its own system, such as a terrestrial mobile system (TMS) 40 may forward an image, radar, depth data such as LIDAR point cloud datums, inSAR data, and other depth data, WiFi, Bluetooth, other wireless signal data, or map data of its environment to the McRS 30A or the aerial system 20A. As noted, a McRS 30A may fuse the TME 240 TMS 40 data into aerially obtained data. In addition, a McRS 30A may forward location, navigational, and map data to the TMS 40A (FIG. 1D), which is implemented within a TME 240 as described further hereinbelow and in connection with FIGS. 2A-C. In some embodiments, references to the position or location of a TME 240 may include information descriptive of the pose of TME 240, in some embodiments described using the commonly-recognized six degrees of freedom (e.g. surge, heave, sway, yaw, pitch and roll). A TME 240 via its TMS 40A-C may use the data to determine its location and the location of assets within the environment, and to navigate TME 240 within the environment.

FIG. 1A is a simplified diagram of a navigation and location architecture (NLA) 10A for terrestrial mobile entities (TME) 240 according to various embodiments. As shown in FIG. 1A, an NLA 10A may include one or more TME 240, 250 moving about an environment 100, a map co-registration system (McRS) 30A, an aerial entity 220, and one or more global navigation systems (GNS) 50A, 50B. As also shown in FIG. 1A, the environment 100 may include one or more navigational pathways 102A, 102B, navigational pathway signs or control signals 104A, 104B, plants or natural assets 106A, 106B, 106C, and buildings 108A, 108B. In an embodiment, the one or more navigational pathways 102A, 102B, the navigational pathway signs or control signals 104A, 104B, the plants or natural assets 106A, 106B, 106C, and the buildings 108A, 108B may all be considered fixed assets or pseudo-fixed assets in an embodiment. In an embodiment, one or more assets 102A-108B may include image, radar, depth data such as LIDAR point cloud datums, inSAR data, and other depth data, WiFi, Bluetooth, other wireless signal data generation modules 110A, 110B, 112 that provide signals that may be received by a TME 240, 250, aerial system 20, or McRS 30, e.g., a navigational pathway sign or control signal 104A, 104B.

An aerial entity 220 via an aerial system 20 may capture and generate map data including one or more digital images 26 of the environment (which may include or consist of optical images orthophotos and orthogrammetry camera data) and topology references including depth datum such as LIDAR point cloud datum, inSAR datum, and other depth datum 28A-28M, inSAR data, and other depth sensor system data. An aerial system 20 may be utilized to quickly provide a highly-accurate (but in some embodiments, relatively low resolution) reference map of a region through which a TME 240, 250 may travel. Such a reference map may provide precisely-located known points of reference for terrestrial vehicles including the location of devices that generate image, radar, depth data such as LIDAR point cloud datums, inSAR data, and other depth data, WiFi, Bluetooth, other wireless signal data of an asset 102A-108B. The aerially-collected reference map may also be used to provide a shared coordinate system that may be used to fuse multiple sets of data subsequently collected by terrestrial entities.

In particular, as shown in FIG. 1A, reference points 28A-28D may be depth data that may represent various locations on the building 108A, reference points 28E-28F may represent locations on the building 108B including devices 110A, 110B, and 112 that may generate image, radar, depth data such as LIDAR point cloud datums, inSAR data, and other depth data, WiFi, Bluetooth, other wireless signal data. Reference points 28G-28I may represent locations on the tree 106A, reference point 28J may represent a location on the tree 106B, and reference point 28K may represent a location on the tree 106C. Further, reference point 28L may represent a location on the navigation pathway sign 104A and reference point 28M may represent a location on the navigation pathway control signal 104B, which may also include devices that generate image, radar, depth data such as LIDAR point cloud datums, inSAR data, and other depth data, WiFi, Bluetooth, other wireless signal data. In an embodiment, each reference or point cloud datum 28A-28M may have an associated location generated in part from the GNS 50A, 50B signals and distance from the aerial entity 220 and thus the ground based on the known altitude of the aerial entity 220 at the time of capture.

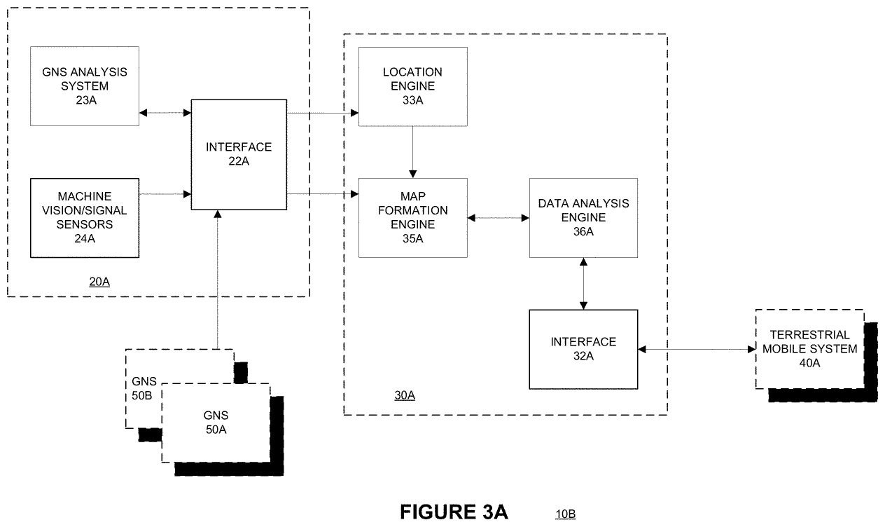

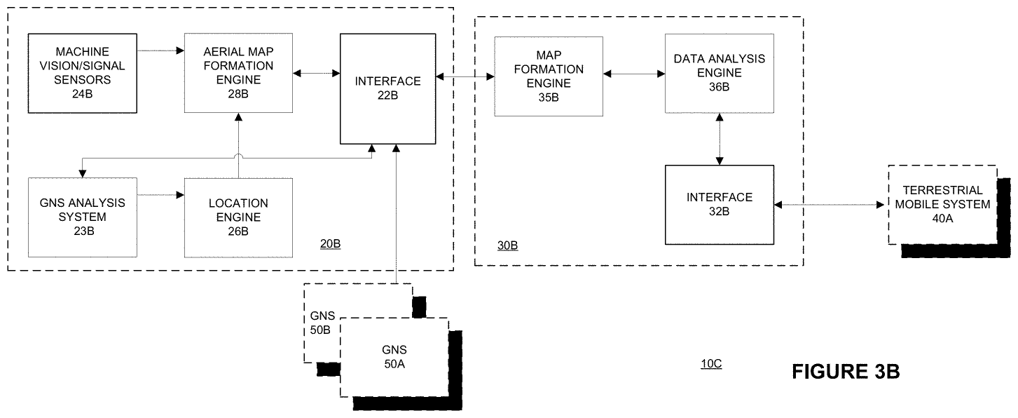

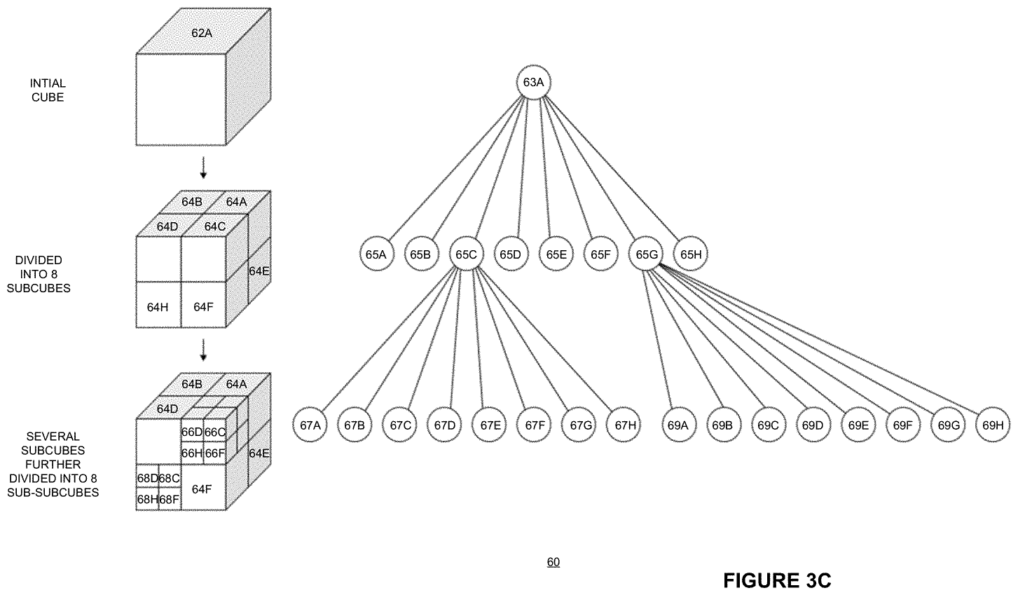

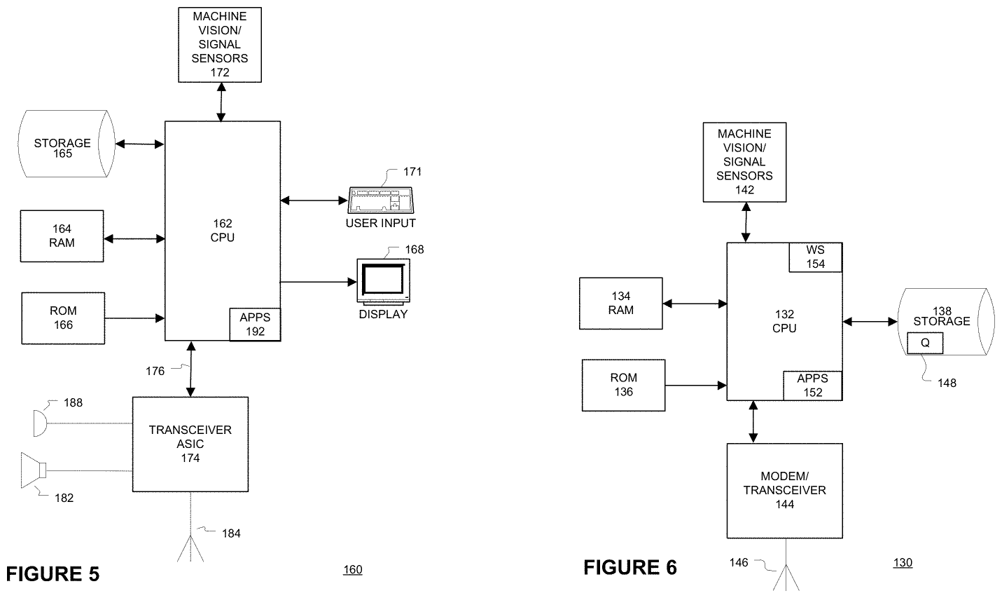

The aerial system 20, McRS 30, TMS 40A, 40B or combination of the systems may form maps from the aerial entity 220 data and TMS 40A, 40B data. The maps may include depth data such as LIDAR point cloud datums, inSAR data, and other depth data anchored or not anchored to various assets on the formed map and may further include 3D structures and details formed from the combination of image and depth data. In an embodiment, an aerial entity 220 may include an aerial system 20. The aerial system 20 may include and employ machine vision/signal sensors (172—FIG. 5, 24A, 24B—FIGS. 3A, 3B). The machine vision/signal sensors 172, 24A, 24B may include a digital image generation unit and a light imaging, depth detection systems including light detection, and ranging (LIDAR) unit, multiple radars creating inSAR, and other signal processing units. The digital image generation unit may generate digital data representing images of the topology with fixed or pseudo-fixed navigation areas and pseudo-fixed assets. The digital image generation unit may include digital camera data including orthophotos and orthogrammetry.

The depth detection systems unit may measure distance to fixed or pseudo-fixed navigation areas and pseudo-fixed assets. A LIDAR based depth detection system may measure such distances by illuminating the fixed or pseudo-fixed navigation areas and pseudo-fixed assets with pulsed laser light and measuring the reflected pulses with sensors. Such distance determinations may also generate or calculate the heights and locations of the illuminated fixed or pseudo-fixed navigation areas and pseudo-fixed assets at multiple locations based on the known altitude of the depth detection systems at the time of capture. The determined locations are termed depth data and may include point cloud datums and inSAR data in an embodiment. The signal processing units may receive wireless signals from satellite, cellular, other aerial devices, and other sources, and use the signals to determine location information for such signal generation units or improve location data.

An aerial entity 220 may communicate with positioning systems such as global navigation systems 50A, 50B to accurately determine its location. The aerial entity 220 may have unobstructed line of sight to four or more global navigation systems 50A, 50B, enabling the aerial system 20 to obtain frequent geolocation signals from the global navigation systems including when a new image is captured via a digital image generation unit or a new range is detected via a depth detection system. In an embodiment, an aerial entity 220 may include any aerial device including an airplane, a drone, a helicopter, a satellite, and balloon-based system. The global navigation systems or networks 50A, 50B may include the US Global Positioning system (GPS), the Russian Global Navigation Satellite System (GLONASS), the European Union Galileo positioning system, the India's NAVIC, Japan's Quasi-Zenith Satellite System, and China's BeiDou Navigation Satellite System (when online). Further, an aerial system 20 may be granted access to (or authorized to receive) data that enables more precise geolocation position determination from a global navigation system 50A, 50B than a TME 240, 250 system 40A-40C, enabling the aerial system 20 to more accurately determine the location of fixed or pseudo-fixed navigation areas and pseudo-fixed assets.

The McRS 30A, aerial system 20, and TMS 40A, 40B may also use previously captured publicly available depth data including LIDAR point cloud datasets and inSAR datasets to enhance its maps including data sets available from many sources including 3rd parties, gathered inhouse and others such as the US geographical survey (see https://catalog.data.gov/dataset/lidar-point-cloud-usgs-national-map) and https://gisgeography.com/free-global-dem-data-sources/. FIG. 1B is a simplified digital image 26A with depth data 28N of a large environmental region 100A that may be generated in part by aerial systems 20 employed in an aerial entity 220 of a navigation and location architecture 10 according to various embodiments. As shown in FIG. 1B, the image 26A may include many overlaid depth data points, in particular LIDAR points 28N, which may be used in part to create a 3D model of the assets 108C in the image. FIG. 1C is a simplified digital image 26B with depth data points, in particular LIDAR points 28O of a smaller environmental region 100B that may be generated in part by aerial systems 20 employed in an aerial entity 220 and TMS 40A, 40B including depth detection systems of a navigation and location architecture 10 according to various embodiments. As shown in FIG. 1C, the image 26B may also include many overlaid depth points or datum 28O, which may be used in part to create a 3D model of the assets 102 in the image.

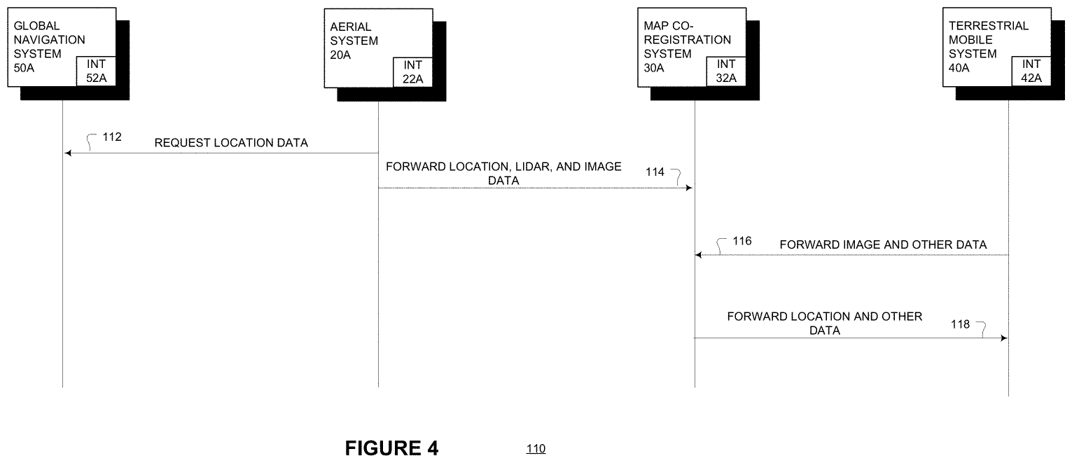

FIG. 4 is a block diagram of communications between a global navigation system 50A, an aerial system 20A of an aerial entity 220, a McRS 30A, and a TMS 40A of a TME 240 in navigation and location architecture 10A shown in FIG. 1A according to various embodiments. As noted above, during image data, depth data, and other data capture, an aerial system 20A may request location data (communication 112) from a GNS 50A. Raw or processed captured image data, depth data, and received location data may be provided from an aerial system 20A to an McRS 30A or TMS 40A, 40B for further processing or coordinated processing of the captured image data, depth data, and received location data (communication 114).

As shown in FIG. 1A, a TME 240 via a TMS 40A may capture and forward digital images 43 of its environment, radar, depth detection systems including light detection, and ranging (LIDAR) unit, multiple radars creating inSAR, WiFi, Bluetooth, other wireless signal data to an McRS 30A (communication 116 of FIG. 4) and aerial systems 20A in an embodiment. The McRS 30A may provide location, navigation, and other data to the TMS 40A based on the forwarded information (communication 118). The TMS 40A may use the data provided from McRS 30A or aerial system 20 in an embodiment to determine or confirm its location or navigate in an environment 100 including receipt of expected wireless signals from assets 102A-108B units 110A-B, cellular signals, satellite 50A, 50B, and other signals in an environment 100. In an embodiment, the MCRS 30A and aerial system 20 navigation data may include different levels of resolution or detail, coverage area, and 2-D and 3D data based on the TMS 40A, TME 240, or request from the TMS 40A. In another embodiment, an McRS 30A may request location, depth data, signal data, and image data from an aerial system 20A in response to a request from a TMS 40A.

In an embodiment, a McRS 30A or aerial system 20 may use TME 240, 250 provided data of its environment to enhance its map data, forming a map fused with data from aerial and terrestrial sources as described. A TME 250 may be directed to move about an environment 10A and periodically, randomly, or be triggered to provide environment data to a McRS 30A where the environment data may include image, radar, depth data, WiFi, Bluetooth, other wireless signal data. It is noted that the data provided to the McRS 30A or aerial system 20 by a TME 240, 250 may be data processed by the TMS 40A-C.

FIG. 1D is a block diagram of a navigation and location architecture 10B for terrestrial mobile entities according to various embodiments. In an embodiment, an architecture 10B may include several aerial systems 20A-B that may be employed at one or more locations to work independently or collectively to with one or more McRS 30A-B and TMS 40A-B. Similarly, architecture 10B may include several McRS 30A-B that may be employed at one or more locations to work independently or collectively with one or more aerial systems 20A-B and TMS 40A-B. As shown in FIG. 1D, a plurality of TMS 40A, 40B may communicate with a McRS 30A, 30B or aerial system 20A, 20B via one or more networks 16A. The networks 16A may include a wireless network including local internet protocol-based network, cellular network, satellite network, or combination thereof. A TMS 40A, 40B may each include a wireless communication interface 42A, 42B that enables real-time wireless communication with an McRS 30A, 30B or aerial system 20A, 20B and environment asset 102A-10B units 110A, 110B. Similarly, an McRS 30A, 30B may each include a wireless communication interface 32A, 32B that enables real-time wireless communication with a TMS 40A, 40B or aerial system 20A, 20B.

A plurality of GNS 50A, 50B may also communicate with an aerial system 20A, 20B, McRS 30A, 30B, and TMS 40A, 40B via one or more networks 16A. A GNS 50A, 50B may each include a wireless communication interface 52A (FIG. 4) that enables real-time wireless communication with an aerial system 20A, 20B, McRS 30A, 30B, and TMS 40A, 40B. Similarly, an aerial system 20A, 20B, McRS 30A, 30B, and TMS 40A, 40B may each include a wireless communication interface 22A-42B that enables real-time wireless communication with a GNS 50A, 50B.

Further, a plurality of McRS 30A, 30B may communicate with an aerial system 20A, 20B via one or more networks 16A in real-time or batch mode. An McRS 30A, 30B may communicate with an aerial system 20A, 20B in real-time via a wireless network and in batch mode via a wireless or wired network. In an embodiment, an McRS 30A, 30B may be co-located with an aerial system 20A, 20B and communicate between each other in real-time via wireless or wired communication networks.

FIG. 2A is a block diagram of a terrestrial mobile system 40A that may be employed in navigation and location architecture 10A for terrestrial mobile entities 240 according to various embodiments. As shown in FIG. 2A, a TMS 40A may include machine vision/signal sensors 44A, a 3D semantic map system 41A, a cognition engine 46A, a location engine 45A, auxiliary mobile entity systems 47A, an interface 42A, and decision engine 48A. The TMS 40A may employ simultaneous localization and mapping (SLAM) via the machine vision/signal sensors 44A, location engine 45A, and 3D semantic map system 41A to provide inputs to a cognition engine 46A and decision engine 48A to control navigation or movement of a TME 240 via the signal 50A.

Architecture 10A via the McRS 30A and aerial systems 20A may enhance or improve SLAM navigation by providing more precise location information to the location engine 45A and initial and updated semantic maps to the 3D semantic map system 41A via the interface 42A. In an embodiment, the machine vision/signal sensors 44A may capture image, radar, depth data, WiFi, Bluetooth, other wireless signal data of an area or region of an environment 100 where their associated TME 240, 250 is currently navigating or more accurately determining its location. The captured image, radar, depth data such as LIDAR point cloud datums, inSAR data, and other depth data, WiFi, Bluetooth, other wireless signal data 43 may be forwarded to an McRS 30A via the interface 42A including an application program interface (API) operating in the interface 42A. The TMS 40A may also send additional data to McRS 30A and aerial system 20 including known location data and auxiliary mobile entity information including known axis information, speed, and direction, position and pose-orientation of TME 240.

The machine vision/signal sensors 44A, 44B, 44C, may include digital image sensors, radar generation and receivers, depth detection systems including light detection, and ranging (LIDAR) unit, multiple radars creating inSAR, and signal processors. The signal processors may analyze wireless signals to determine location based on knowledge of wireless signal antenna(s) 110A, 110B where the wireless signals may be received by the sensors 44A or interface 42A. The wireless signals may be Wifi, cellular, Bluetooth, WiMax, Zigbee, or other wireless signals.

In an embodiment, the machine vision/signal sensors 44A, location engine 45A, 3D semantic map system 41A, and cognition engine 46A may record landmarks or assets within a local environment based on location, processed data such as image, radar, depth data such as LIDAR point cloud datums, inSAR data, and other depth data, WiFi, Bluetooth, and other wireless signal data to create signatures, including voxel signatures, associated with the landmark or asset. The image, radar, depth data such as LIDAR point cloud datums, inSAR data, and other depth data, WiFi, Bluetooth, other wireless signal data captured via sensors 44A-C may be correlated with previously created signatures including voxel signatures via the cognition engine 46A to determine a TME 240 location. In an embodiment, a TMS 40A may forward signatures including voxel signatures in addition to, or in lieu of, image, radar, depth data such as LIDAR point cloud datums, inSAR data, and other depth data, WiFi, Bluetooth, other wireless signal data, to an McRS 30A or aerial system 20A.

Depending on criteria utilized for determination of a signature such voxel or wireless source, the association between a signature and a particular observed landmark, asset, or wireless signal, radar, and depth data source may be unique or almost unique, particularly within a given local environment 100. By matching at least one, and preferably more than one, observed signature within local environment 100, with previously determined signatures and their associated locations (preferably determined using techniques providing greater accuracy than may be possible using equipment onboard TME 240), an accurate location for TME 240 may be determined. For example, a McRS 30A or aerial system 20A may form voxel and wireless signal, radar, and depth data source signatures during map formation and correlate image, radar, depth data such as LIDAR point cloud datums, inSAR data, and other depth data, WiFi, Bluetooth, other wireless signal data and signatures provided by a TMS 40A to determine the TMS 40A location. In an embodiment, an McRS 30A may form signatures from image, radar, depth data such as LIDAR point cloud datums, inSAR data, and other depth data, WiFi, Bluetooth, other wireless signal data provided by a TMS 40A reducing the hardware needed in a TMS 40A of a TME 240. Voxel signatures, correlations, cognition engines, and location engines are described in co-pending PCT application PCT/US2017/022598, filed Mar. 15, 2017, entitled “SYSTEMS AND METHODS FOR PROVIDING VEHICLE COGNITION”, and common applicant, which is hereby incorporated by reference for its teachings. As described, other methods may be employed to fuse datasets between systems 20A, 30, and 40A.

In an embodiment, a McRS 30A (or aerial system 20A) may forward or download signature(s) tables to a TME 240, 250 TMS 40A based on data provided by the TMS 40A. The signature tables may cover a region about the location or area indicated by the TMS 40A data. A TMS 40A may then use the provided signature table(s) data to determine its location within and navigate about an environment 10A-C in addition to or in combination with point cloud datums and other data provided by a McRS 30A (or aerial system 20A). In another environment, a McRS 30A (or aerial system 20A) may use the data provided by a TME 240, 250 to determine the TME 240, 250 location by evaluating signature tables and then provide appropriate location data and signature tables to a TME 240, 250 TMS 40A. As shown in FIGS. 2B-C, a McRS 30A (or aerial system 20A) may accurately determine a location of a TME 240, 250 with limited interaction with its TMS 40B-C, thereby limiting the requirements of the TMS 40B-C.

FIG. 2B is a block diagram of another terrestrial mobile system 40B that may be employed in navigation and location architecture 10A for terrestrial mobile entities 240 according to various embodiments. As shown in FIG. 2B, TMS 40B is similar to TMS 40A but without a cognition engine and with a simplified 3D semantic map system 41B. As noted, a TMS 40B may provide a captured image, radar, depth data such as LIDAR point cloud datums, inSAR data, and other depth data, WiFi, Bluetooth, other wireless signal data 43 and related data to an McRS 30A or aerial system 20A. The McRS 30A or aerial system 20A may provide location, related image, radar, depth data such as LIDAR point cloud datums, inSAR data, and other depth data, WiFi, Bluetooth, other wireless signal data and 3D semantic map information to the TMS 40B via the interface 42B reducing the functionality and thus hardware needed in a TMS 40B enabling a TMS 40B to be employed in more and smaller TME 240. The TMS 40B may not provide, receive, or employ asset signature tables including voxel tables to navigate or determine location due to the data provided by the McRS 30A or aerial system 20A.

FIG. 2C is a block diagram of a further simplified terrestrial mobile system 40C that may be employed in navigation and location architecture 10A for terrestrial mobile entities 240 according to various embodiments. As shown in FIG. 2C, TMS 40C is similar to TMS 40B and TMS 40A but without a cognition engine, a location engine, or a 3D semantic map system. In an embodiment, a TMS 40C may provide a captured image, radar, depth data such as LIDAR point cloud datums, inSAR data, and other depth data, WiFi, Bluetooth, other wireless signal data 43 and related data to an McRS 30A or aerial system 20A. The McRS 30A or aerial system 20A may provide location data, related image, radar, depth data such as LIDAR point cloud datums, inSAR data, and other depth data, WiFi, Bluetooth, other wireless signal data, and 3D semantic map information to the TMS 40C decision engine 48C via the interface 42C further reducing the functionality and thus hardware needed in a TMS 40C. A TMS 40C may be employed in a low altitude drone, simple robot (such sidewalk robots and delivery robots or vehicles), laptops, mobile phones, tablets, and other small format, battery conscious, or cost conscious TME 240.

FIG. 3A is a block diagram of a navigation and location architecture 10B for terrestrial mobile entities 240, 250 according to various embodiments. As shown in FIG. 3A, an aerial system 20A of an aerial entity 220 may include machine vision/signal sensors 24A, a global navigation system (GNS) analysis system 23A, and an interface 22A. The McRS 30A may include a location engine 33A, a map formation engine 35A, a data analysis engine 36A, and an interface 32A. As noted, the aerial system 20A machine vision sensors 24A may include an image, radar, depth detection systems including light detection, and ranging (LIDAR) unit, multiple radars creating inSAR, WiFi, Bluetooth, other wireless signal data sensors/processors. The interface 22A may forward digital image, radar, depth detection systems including light detection, and ranging (LIDAR) unit, multiple radars creating inSAR, WiFi, Bluetooth, other wireless signal data from the sensors 24A to the map formation engine 35A or a TMS 40A, 40B via the interface 22A in real time or batch mode.

The GNS analysis system 23A may receive navigation signals from GNS 50A-50B via the interface 22A, process the signals to determine the current position of the aerial system 20A, in particular the sensors 24A. The position data may be forwarded to the location engine 33A via the interface 22A in real-time or batch mode. The position data and sensor data may be synchronized and include time stamps to enable their synchronization in real-time or batch mode by the location engine 33A and map formation engine 35A in an embodiment. The location engine 33A of the McRS 30A may convert the GNS analysis system data 23A to coordinates usable by the map formation engine 35A. The location engine 33A may also work with the data analysis engine 36A to determine the location of data represented by image, radar, depth detection systems including light detection, and ranging (LIDAR) unit, multiple radars creating inSAR, WiFi, Bluetooth, other wireless signal data received by a TMS 40A in an embodiment.

The map formation engine 35A may use the position data as processed by the location engine and the image, radar, depth detection systems including light detection, and ranging (LIDAR) unit, multiple radars creating inSAR, WiFi, Bluetooth, other wireless signal data from the aerial system 20A or a TMS 40A, 40B to generate or modify a map of a region represented by the data. The map formation engine 35A may form a 3D or structural map of the region(s) based on the new data and existing map data. The map formation engine 35A may analyze the formed 3D map to locate assets in the map and form signatures with associated location data for the located assets including voxel signatures. The resultant 3D map and asset signatures may be stored in databases that may be forwarded in part to a TMS 40A or aerial system 20A in an embodiment. In an embodiment, the map formation engine 35A may also receive image and other data from a TME 240, 250 TMS 40A and update and fuse the data into its map as described above.

The stored 3D map and asset signatures may also be used by the data analysis engine 36A. In an embodiment, the data analysis engine 36A may receive image, radar, depth detection systems including light detection, and ranging (LIDAR) unit, multiple radars creating inSAR, WiFi, Bluetooth, other wireless signal data from a TMS 40A and analyze the data to determine the current location of the TMS 40A based on the stored 3D map and asset signatures. The data analysis engine 36A may forward location data and map data to the TMS 40A and aerial system 20A as function of the request from the TMS 40A-C or aerial system 20A. As noted, some TMS 40A-C may perform more local analysis than other TMS 40A-C. Accordingly, the data analysis engine 36A may form different resolution and environment size/volume 3D maps as described in reference to FIG. 3C and forward the data to the requesting TMS 40A-C or aerial system 20A.

In an embodiment, a TMS 40A-C may forward image, radar, depth data such as LIDAR point cloud datums, inSAR data, and other depth data, WiFi, Bluetooth, other wireless signal data and other data including location data and motion data to an McRS 30A or aerial system 20A. The map formation engine 35A or aerial system 20A may analyze the image, radar, depth data such as LIDAR point cloud datums, inSAR data, and other depth data, WiFi, Bluetooth, other wireless signal data to form structure for multiple data sets and signatures as a function of the image, radar, depth data such as LIDAR point cloud datums, inSAR data, and other depth data, WiFi, Bluetooth, other wireless signal data and any location data provided by a TMS 40A. While localization systems implemented locally on TMS 40A may not be as accurate as needed to precisely navigate an environment or determine the TMS 40A-C position therein, TMS 40A may indicate its best approximation of location, enabling definition of a smaller region within a 3D map (and thus a smaller set of related asset signature data) to analyze and more precisely determine the location of the TMS 40A-C.

FIG. 3B is a block diagram of another navigation and location architecture 10C for terrestrial mobile entities 240 according to various embodiments where the aerial system 20B may perform analysis on data as it collects it. As shown in FIG. 3B, the aerial system 20B may include an aerial map formation engine 28B and a location engine 26B in addition to the other components of the aerial system 20A. The aerial system 20B may form 3D maps and signature tables in conjunction with the location engine 26B based on local data and stored, previous map and signature data and data received from a McRS 30A and TMS 40A. The resultant aerial system 20B 3D map data and signature data may be forwarded to the McRS 30B map formation engine 35B via the interface 22B and TMS 40A in an embodiment.

The McRS 30B map formation engine 35B or TMS 40A, 40B may analyze and process the aerial system 20B 3D map data and signature data (datasets) along with location data from the location engine 26B to update or form 3D map data and related asset signature data in an embodiment. In an embodiment, the map formation engines 28B, 35A, 35B may use a structure from motion analysis to form a 3D map based on continuous data received from a moving aerial system 20. As noted above, systems 20A, 30A, 40A may use several methods or combination thereof to fuse datasets from each other. The addition of image, radar, depth data such as LIDAR point cloud datums, inSAR data, and other depth data, WiFi, Bluetooth, other wireless signal data may enable the map formation engine 35A to generate more precise 3D maps versus standard structure by motion maps. The image, radar, depth data such as LIDAR point cloud datums, inSAR data, and other depth data, WiFi, Bluetooth, other wireless signal data may provide a framework for blending structures within moving image data more accurately in an embodiment. In an embodiment, LIDAR sensors may be accurate to 5 cm and also provide a low-resolution image of an environment 10A-C represented by all the LIDAR data. In particular, image, radar, depth data such as LIDAR point cloud datums, inSAR data, and other depth data, WiFi, Bluetooth, other wireless signal data may be used to improve the addition of new images to initial two-view construction models employed in structure by motion analysis/techniques, convex optimization, or systems 20A, 30A, 40A may use several methods or combination thereof to fuse datasets from each other.

In an embodiment, the aerial system 20A-B or TMS 40A, 40B machine vision/signal sensors may include one or more LiDAR laser scanners to collect and form geographic point cloud data. The geographic LiDAR data may be formatted as, for example, ASPRS (American Society for Photogrammetry and Remote Sensing) standard format know as LAS (LiDAR Aerial Survey), its (LAS) compressed format LAZ, raw, ASCII (.xyz), or raw format. A map formation engine 28B, 35B may process the LIDAR data based on its format. Deploying an aerial entity 220 with an aerial system 20 is substantially more affordable than traditional terrestrial mapping systems. As noted, an aerial system 20 may have clearer line of sight to GNS 50A-B than a terrestrial mapping system enabling the aerial system 20 to obtain more frequent and accurate position or location data. In addition, as noted there are publicly available aerially-collected LIDAR maps. For example, the city of San Francisco, California publishes centerline aerial data publicly with 50 points of LIDAR data per square meter.

In an embodiment, an McRS 30A, aerial system 20A, or combination as shown in FIGS. 3A and 3B may use aerially-collected data including depth data such as LIDAR point cloud datums, inSAR data, and other depth data to improve terrestrial maps and location data including structures within the terrestrial maps. As shown in FIG. 1A-C, aerially-collected data may provide accurate mapping of assets 108A-C, 106A-C, 104A-C, 102A-B in an environment 100, 100A, and 100B. In an embodiment, lower cost systems (TMS 40B-C) may be employed in terrestrial entities 240, 250 to obtain initial map data including location data and signature data for an environment 100. The depth data such as LIDAR point cloud datums, inSAR data, and other depth data and other aerial system 20 data may be used to correct or improve the initial TMS 40 generated data.

As TME 240 with an TMS 40 navigate through an environment 100, the aerial formed map and signature data may be eventually be replaced by or supplemented with, in whole or in any part, TMS 40 signature data. The replaced or additional data may provide more reliable localization (such as by observing assets from a terrestrial perspective, potentially including assets partially or wholly obscured from the vantage point of an aerial system 20), while utilizing the initial aerial map as precisely-localized guide points within a depth datum such as point cloud datums, inSAR datums, and other depth datums. In an embodiment, a TMS 40 may be an application embedded on a TME user's cell phone or other data capturing device, such as insta-360, Vuze, Ricoh Theta V, Garmin Virb 360, Samsung 360, Kodak Pixpro SP360, LyfieEye200, and others. In an embodiment, a TME 240 may include a delivery, Uber, UPS, FedEx, and Lyft vehicles, robots including delivery robots, mobile units such as micro-mobility solutions such as rental scooters (such as Bird and Lime) and bicycles (such as Jump) may include basic data capture devices where the captured data may be forwarded to an McRS 30 or aerial system 20A for processing in real-time or batch mode. In an embodiment, a TMS 40A, 40B of a TME 240 may not fully automate the operation of a TME 240. A TMS 40A, 40B may provide assisted navigation, enhanced maps, and emergency controls for occupied TMEs 240.

As noted in an embodiment, an aerial system 20 may provide real time data to a McRS 30 and a TMS 40 including location of pseudo-assets 108A-C, 106A-C, 104A-C, 102A-B and dynamic assets such as TME 240 in an environment 100, 100A, and 100B. In an embodiment, a TMS 40C may be embedded on a mobile device such as cellphone with data capture. A user via the TMS 40C may collect image, radar, depth data such as LIDAR point cloud datums, inSAR data, and other depth data, WiFi, Bluetooth, other wireless signal data and communicate the data to a McRS 30 or aerial system 20A via an application on their device. An McRS 30A or aerial system 20A may process the image, radar, depth data such as LIDAR point cloud datums, inSAR data, and other depth data, WiFi, Bluetooth, other wireless signal data to determine the User's precise location via the image, radar, depth data such as LIDAR point cloud datums, inSAR data, and other depth data, WiFi, Bluetooth, other wireless signal data by correlating assets 108A-C, 106A-C, 104A-C, 102A-B in the image, radar, depth data such as LIDAR point cloud datums, inSAR data, and other depth data, WiFi, Bluetooth, other wireless signal data 43 to known image, radar, depth data such as LIDAR point cloud datums, inSAR data, and other depth data, WiFi, Bluetooth, other wireless signal data or signatures of assets 108A-C, 106A-C, 104A-C, 102A-B. In an embodiment, an McRS 30 or aerial system 20A may determine signatures for assets in provided image, radar, depth data such as LIDAR point cloud datums, inSAR data, and other depth data, WiFi, Bluetooth, other wireless signal data 43 and correlate the observed signatures to stored signatures.

An McRS 30 or aerial system 20A may then return a precise location based on the image, radar, depth data such as LIDAR point cloud datums, inSAR data, and other depth data, WiFi, Bluetooth, other wireless signal data to the requesting application. An McRS 30 or aerial system 20A may provide other data with the location data including pose estimation of the sensors that captured the image, radar, depth data such as LIDAR point cloud datums, inSAR data, and other depth data, WiFi, Bluetooth, other wireless signal data. The location application on a User's device may enable a User to request services to be provided at the location such a ride service, delivery service, or emergency services.

As noted, an aerial system 20, McRS 30, TMS 40A or combination of both systems may form maps based on existing maps, depth data such as LIDAR point cloud datums, inSAR data, and other depth data data and/or image data and TME 240, 250 provided image, radar, depth data such as LIDAR point cloud datums, inSAR data, and other depth data, WiFi, Bluetooth, other wireless signal data as a TME 240, 250 progresses through an environment 100A-C. The resultant map may be a fused map or semantic map in an embodiment or formed by other methods including those described herein.

The resultant map(s) may consume large volume(s) of data. In an embodiment, multi-resolution maps may be employed. The different resolution maps may be stored by an on-premise, private cloud, or 3rd party storage providers for an aerial system 20, McRS 30, and TMS 40A, 40B. 3rd party storage providers may include cloud service providers such Amazon Web Services (AWS), Microsoft Azure, Google Cloud, Alibaba Cloud, IBM, Oracle, Virtustream, CenturyLink, Rackspace and others. Different resolution maps of environments 100 may be downloaded to an aerial system 20, McRS 30, or TMS 40A-C as a function of the application or processing state. In an embodiment, an Octree structure 60 may be employed to provide different resolution or dimension 3D maps as shown in FIG. 3C. An initial lower resolution 3D map 63A encompassing a particular spatial volume 62A may be provided. Higher resolution, smaller volume 3D maps 65A-65H encompass volumes 64A-64H, respectively, with each volume 64A-64H comprising one-eighth of the volume 62A. Each map 65 may be subdivided into yet higher resolution and smaller volume maps. For example, map 65C containing map content associated with volume 64C is subdivided into maps 67A-67H, containing map content associated with volume 66A-66H, respectively. Similarly, map 65G is subdivided into maps 69A-69H, containing map content associated with volume 68A-68H, respectively. Such maps 63, 65, 67 and 69 may be employed or downloaded to an aerial system 20, McRS 30, or TMS 40A-C as a function of the application and processing being performed on a map in an embodiment, thereby potentially reducing local storage requirements and/or download bandwidth requirements. More or fewer levels of map and volume subdivision may be employed for a particular local environment, depending on, e.g., system requirements and the availability of appropriate data. While octree-based spatial subdivision is preferred to facilitate use in movement through three-dimensional space, it is contemplated and understood that in other embodiments, other schemes for subdividing map data may be employed.

In an embodiment the networks 16A may represent several networks and support and enable communication in architectures 10A-C and the signals generated by antenna 110A, 110B in environments 100A, 100B may support many wired or wireless protocols using one or more known digital communication formats including a cellular protocol such as code division multiple access (CDMA), time division multiple access (TDMA), Global System for Mobile Communications (GSM), cellular digital packet data (CDPD), Worldwide Interoperability for Microwave Access (WiMAX), satellite format (COMSAT) format, and local protocol such as wireless local area network (commonly called “WiFi”), Near Field Communication (NFC), radio frequency identifier (RFID), ZigBee (IEEE 802.15 standard), edge networks, Fog computing networks, and Bluetooth.

As known to one skilled in the art, the Bluetooth protocol includes several versions including v1.0, v1.0B, v1.1, v1.2, v2.0+EDR, v2.1+EDR, v3.0+HS, and v4.0. The Bluetooth protocol is an efficient packet-based protocol that may employ frequency-hopping spread spectrum radio communication signals with up to 79 bands, each band 1 MHz in width, the respective 79 bands operating in the frequency range 2402-2480 MHz. Non-EDR (extended data rate) Bluetooth protocols may employ a Gaussian frequency-shift keying (GFSK) modulation. EDR Bluetooth may employ a differential quadrature phase-shift keying (DQPSK) modulation.

The WiFi protocol may conform to an Institute of Electrical and Electronics Engineers (IEEE) 802.11 protocol. The IEEE 802.11 protocols may employ a single-carrier direct-sequence spread spectrum radio technology and a multi-carrier orthogonal frequency-division multiplexing (OFDM) protocol. In an embodiment, one or more devices 30A-F, implementation controllers 40A, 40B, and hardware implementations 20A-D may communicate in in architecture 10A-D and 50A-50C via a WiFi protocol.

The cellular formats CDMA, TDMA, GSM, CDPD, and WiMax are well known to one skilled in the art. It is noted that the WiMax protocol may be used for local communication between the one or more TMS 40A-C and McRS 30A-B. The WiMax protocol is part of an evolving family of standards being developed by the Institute of Electrical and Electronic Engineers (IEEE) to define parameters of a point-to-multipoint wireless, packet-switched communications systems. In particular, the 802.16 family of standards (e.g., the IEEE std. 802.16-2004 (published Sep. 18, 2004)) may provide for fixed, portable, and/or mobile broadband wireless access networks.

Additional information regarding the IEEE 802.16 standard may be found in IEEE Standard for Local and Metropolitan Area Networks—Part 16: Air Interface for Fixed Broadband Wireless Access Systems (published Oct. 1, 2004). See also IEEE 802.16E-2005, IEEE Standard for Local and Metropolitan Area Networks—Part 16: Air Interface for Fixed and Mobile Broadband Wireless Access Systems—Amendment for Physical and Medium Access Control Layers for Combined Fixed and Mobile Operation in Licensed Bands (published Feb. 28, 2006). Further, the Worldwide Interoperability for Microwave Access (WiMAX) Forum facilitates the deployment of broadband wireless networks based on the IEEE 802.16 standards. For convenience, the terms “802.16” and “WiMAX” may be used interchangeably throughout this disclosure to refer to the IEEE 802.16 suite of air interface standards. The ZigBee protocol may conform to the IEEE 802.15 network and two or more devices TMS 40A-C may form a mesh network. It is noted that TMS 40A-C may share data and location information in an embodiment.

A device 160 is shown in FIG. 5 that may be used in various embodiments as an TMS 40A-C. The device 160 may include a central processing unit (CPU) 162, a random-access memory (RAM) 164, a read only memory (ROM) 166, a display 168, a user input device 172, a transceiver application specific integrated circuit (ASIC) 174, a microphone 188, a speaker 182, a storage unit 165, machine vision/signal sensors 172, and an antenna 284. The CPU 162 may include an application module 192.

The storage device 165 may comprise any convenient form of data storage and may be used to store temporary program information, queues, databases, maps data, signature data, and overhead information. The ROM 166 may be coupled to the CPU 162 and may store the program instructions to be executed by the CPU 162, and the application module 192. The RAM 164 may be coupled to the CPU 162 and may store temporary program data, and overhead information. The user input device 172 may comprise an input device such as a keypad, touch screen, track ball or other similar input device that allows the user to navigate through menus, displays in order to operate the device 160. The display 168 may be an output device such as a CRT, LCD, touch screen, or other similar screen display that enables the user to read, view, or hear received messages, displays, or pages. The machine vision/signal sensors 172 may include digital image capturing sensors, RADAR, depth detection systems including light detection, and ranging (LIDAR) unit, multiple radars creating inSAR, wireless signals, and other sensors in an embodiment.

A microphone 188 and a speaker 182 may be incorporated into the device 160. The microphone 188 and speaker 182 may also be separated from the device 160. Received data may be transmitted to the CPU 162 via a bus 176 where the data may include messages, map data, sensor data, signature data, displays, or pages received, messages, displays, or pages to be transmitted, or protocol information. The transceiver ASIC 174 may include an instruction set necessary to communicate messages, displays, instructions, map data, sensor data, signature data or pages in architectures 10A-C. The ASIC 174 may be coupled to the antenna 184 to communicate wireless messages, displays, map data, sensor data, signature data, or pages within the architectures 10A-C. When a message/data is received by the transceiver ASIC 174, its corresponding data may be transferred to the CPU 162 via the bus 176. The data can include wireless protocol, overhead information, map data, sensor data, signature data and pages and displays to be processed by the device 160 in accordance with the methods described herein.

FIG. 6 illustrates a block diagram of a device 130 that may be employed as an aerial system 20, 20A, 20B and McRS 30, 30A, 30B in various embodiments. The device 130 may include a CPU 132, a RAM 134, a ROM 136, a storage unit 138, a modem/transceiver 144, machine vision/signal sensors 142, and an antenna 146. The CPU 132 may include a web-server 154 and application module 152.

The modem/transceiver 144 may couple, in a well-known manner, the device 130 to the network 16A to enable communication with an aerial system 20, 20A, 20B and McRS 30, 30A, 30B, TMS 40, 40A, 40B, 40C, and GNS 50A, 50B. In an embodiment, the modem/transceiver 144 may be a wireless modem or other communication device that may enable communication with an aerial system 20, 20A, 20B and McRS 30, 30A, 30B, TMS 40, 40A, 40B, 40C, and GNS 50A, 50B.

The ROM 136 may store program instructions to be executed by the CPU 132. The RAM 134 may be used to store temporary program information, queues, databases, map data, sensor data, and signature data and overhead information. The storage device 138 may comprise any convenient form of data storage and may be used to store temporary program information, queues 148, databases, map data, sensor data, and signature data, and overhead information.

Any of the components previously described can be implemented in a number of ways, including embodiments in software. Thus, the CPU 132, modem/transceiver 144, antenna 146, storage 138, RAM 134, ROM 136, CPU 162, transceiver ASIC 174, antenna 184, microphone 188, speaker 182, ROM 166, RAM 164, user input 172, display 268, aerial system 20, 20A, 20B and McRS 30, 30A, 30B, TMS 40, 40A, 40B, 40C, and GNS 50A, 50B may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications. They are not intended to serve as a complete description of all the elements and features of apparatus and systems that might make use of the structures described herein. For example, in an embodiment as noted, an aerial system 20 may update its datasets based on data or datasets provided by a TMS 40A, 40B. In addition, an aerial system 20, McRS 30, and TMS 40A, 40B may employ machine learning or artificial intelligence algorithms to aid in the formation and interpretation of fused maps including datasets from several sources. For example, an aerial system 20 may employ machine learning or artificial intelligence algorithms to form or update fused maps with data it collects and receives from other aerial systems 20, McRS 30, and TMS 40A, 40B.

The machine learning or artificial intelligence algorithms knowledge may be shared across an entire navigation and location architecture 10 so any of the systems 20, 30, 40 may learn from each other and improve the formation and improvement of fused maps and related datasets. Such use and distribution of machine learning or artificial intelligence algorithms may enable the models that the fused maps and datasets to include color information added to aerial imagery (from an aerial system 20) where the enhanced imagery may detect and show road edges of navigation pathways 102 more accurately due to the detection and determination of color differences in the image data enhanced with depth data, such LIDAR depth data and intensity from a TMS 40A, which may illuminate more curb (road edge) details. The employment of machine learning or artificial intelligence algorithm may enhance and improve the correlation of datasets from different types of sensors as well as different observation angles from architecture 10 systems 20, 30, 40.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A computer-implemented method of creating a map of an environment, the method comprising:
receiving a dataset from a terrestrial mobile entity (TME) system including on-board machine vision sensors, the TME system dataset including machine vision sensor data;
receiving a dataset from an aerial system including on-board machine vision and signal sensors, the aerial system dataset including location data and one of image data and depth data of the environment;
forming a three-dimensional (3D) semantic map from the received aerial system dataset and the TME system dataset.

2. The computer-implemented method of claim 1, further including determining a location of the TME based on the formed 3D semantic map and the received TME system dataset.

3. The computer-implemented method of claim 2, further including forwarding the determined location of the TME to the TME system.

4. The computer-implemented method of claim 1, wherein the aerial system dataset includes location data and depth data of the environment and each datum of the depth data of the aerial system dataset has associated location data and fusing the received TME system dataset and the received aerial system dataset based on the depth data and location data to form an enhanced three-dimensional (3D) semantic map.

5. The computer-implemented method of claim 4, including analyzing the enhanced three-dimensional (3D) semantic map to detect a plurality of pseudo-fixed assets for the environment and adding one of multiple viewpoints in an environment, color, and intensity for each pseudo-fixed asset of the detected plurality of pseudo-fixed assets in the environment to the enhanced three-dimensional (3D) semantic map.

6. The computer-implemented method of claim 4, further including analyzing the enhanced three-dimensional (3D) semantic map to detect a plurality of pseudo-fixed assets for the environment and determining unique signatures for each pseudo-fixed asset of the detected plurality of pseudo-fixed assets.

7. The computer-implemented method of claim 6, wherein each determined unique signature for each pseudo-fixed asset of the plurality of pseudo-fixed assets includes an associated datum from the depth data of the received aerial system dataset.

8. The computer-implemented method of claim 1, wherein the received TME system dataset has higher image resolution than the aerial system dataset.

9. The computer-implemented method of claim 1, wherein the received TME system dataset has lower location accuracy than the aerial system dataset.

10. The computer-implemented method of claim 1, further including analyzing the received aerial system dataset to detect a plurality of pseudo-fixed assets and determining unique signatures for each pseudo-fixed asset of the plurality of pseudo-fixed assets.

11. The computer-implemented method of claim 10, further including analyzing the received TME system dataset to detect a plurality of pseudo-fixed assets and determining signatures for any pseudo-fixed assets in the received TME system dataset and correlating the determined signatures for any pseudo-fixed assets in the received TME system dataset with the determined signatures for any pseudo-fixed assets in the received aerial system dataset to fuse the received TME system dataset and the received aerial system dataset to form an enhanced three-dimensional (3D) semantic map.

12. The computer-implemented method of claim 11, wherein the received TME system dataset includes one of image, radar, LIDAR, WiFi, Bluetooth, other wireless signal data representing the environment about the TME.

13. The computer-implemented method of claim 11, wherein each determined unique signature for each pseudo-fixed asset of the plurality of pseudo-fixed assets in the received aerial system dataset includes an associated datum from the depth data.

14. The computer-implemented method of claim 12, wherein the determined signatures are voxel signatures.

15. The computer-implemented method of claim 1, including updating a three-dimensional (3D) semantic map developed from other datasets based on the received aerial system dataset and the TME system dataset.

16. A computer-implemented method of localizing a terrestrial mobile entity (TME) having a system including an on-board machine vision and signal sensors in an environment, the method comprising:
at the TME system including machine vision sensors, collecting image data of the environment about the TME to form a TME system dataset;
forwarding the TME system dataset to a map co-registration system (McRS);
at the TME system receiving a three-dimensional (3D) semantic map from the McRS based on the forwarded TME system dataset, the 3D semantic map formed from an aerial system dataset, the aerial system including on-board machine vision and signal sensors and the aerial system dataset including location data and one of image data and depth data of the environment; and
at the TME system determining the TME location based on the received 3D semantic map and the TME system dataset.

17. The computer-implemented method of claim 16, wherein the aerial system dataset includes location data and depth data of the environment and each datum of the depth data of the aerial system dataset has associated location data.

18. The computer-implemented method of claim 16, further including at the TME system receiving a plurality of determined unique signatures, each for a pseudo-fixed asset of a plurality of pseudo-fixed assets detected in the 3D semantic map by the McRS based on the aerial system dataset.

19. The computer-implemented method of claim 18, wherein the aerial system dataset includes location data and depth data of the environment and each determined unique signature for each pseudo-fixed asset of the plurality of determined unique signatures includes an associated datum from the aerial system dataset depth data.

20. The computer-implemented method of claim 17, further including at the McRS determining signatures for any pseudo-fixed assets in the TME system dataset and correlating the determined signatures for any pseudo-fixed assets in the TME system with the plurality of determined unique signatures formed from the aerial system dataset and forming the three-dimensional (3D) semantic map in part based on the correlation.
